(19) United States
(12) Patent Application Publication
(10) Pub. No.: US 2010/0184450 A1
(43) Pub. Date: Jul. 22, 2010

(54) METHOD AND SYSTEM FOR CONTROLLING PARAMETERS OF A COMMUNICATION CHANNEL BETWEEN A FEMTOCELL AND A CELLULAR ENABLED COMMUNICATION DEVICE

(76) Inventors: Xuemin Sherman Chen, San Diego, CA (US); Charles Abraham, Los Gatos, CA (US); Wael William Diab, San Francisco, CA (US); Vinko Erceg, Cardiff, CA (US); Victor T. Hou, La Jolla, CA (US); Jeyhan Karaoguz, Irvine, CA (US); Mark Kent, Vista, CA (US)

Correspondence Address: MCANDREWS HELD & MALLOY, LTD, 500 WEST MADISON STREET, SUITE 3400, CHICAGO, IL, 60661, US

(21) Appl. No.: 12/355,537

(22) Filed: Jan. 16, 2009

(51) Int. Cl. H04W 74/00

(52) U.S. Cl. 455/455

(57) ABSTRACT

Aspects of a method and system for controlling parameters of a communication channel between a femtocell and a cellular enabled communication device are provided. In this regard, characteristics of a cellular communication channel established between a cellular enabled communication device and the femtocell may be communicated to a network management entity. The network management entity may determine whether to adjust one or more parameters of the cellular communication channel based on the characteristics. The femtocell and/or the cellular enabled communication device may adjust the one or more parameters based on the determination by the management entity. The characteristics may be determined by the femtocell and/or the cellular enabled communication device. The characteristics may comprise one or more of signal strength, bit error rate, packet error rate, and/or available bandwidth. The parameters may comprise one or more of data rate modulation scheme, error coding scheme, and/or transmitted power levels.

### CROSS-REFERENCE TO RELATED APPLICATIONS/INCORPORATION BY REFERENCE

Not applicable.

### FIELD OF THE INVENTION

Certain embodiments of the invention relate to communications. More specifically, certain embodiments of the invention relate to a method and system for controlling parameters of a communication channel between a femtocell and a cellular enabled communication device.

### BACKGROUND OF THE INVENTION

A femtocell may be placed in a customer's residence or in a small business environment, for example. Femtocells may be utilized for off-loading macro radio network facilities, improving coverage locally in a cost-effective manner, and/or implementing home-zone services to increase revenue. Femtocells, like macro base stations, may be enabled to connect “standard” phones to a cellular provider's network by a physical broadband connection which may be a digital subscriber line (DSL) connection and/or a cable connection, for example. Since the traffic between a customer's premises femtocell equipment and the operator's network may be traversing a public network, the traffic may be prone to various risks.

Communication between femtocells and one or more cellular provider's networks enables operation in private and public areas. The capacity of a femtocell may be adequate to address a typical family use model supporting two to four simultaneous voice calls and/or data, for example.

An important characteristic of femtocells is their ability to control access. In an open access scenario, any terminal and/or subscriber may be allowed to communicate with the femtocell. Accordingly, the femtocell usage may somewhat resemble that of a macrocellular system. In a closed access scenario, the femtocell may serve a limited number of terminals and/or subscribers that may be subscribed to a given cellular base station. In this regard, the cellular base station may be perceived as being deployed for private usage.

A regulatory issue with regard to femtocells is that they use licensed frequencies that radiate at a very low power in a controlled environment. It may be likely that they may not require a license from a local authority, as macrocellular base stations do. An additional regulatory issue may arise from the relationship between a femtocell operator and a broadband services operator. One possible scenario may include the broadband operator being unaware of the existence of a femtocell operator. Conversely, the broadband operator and femtocell operator may have an agreement or they may be the same operator, for example. Interference between femtocells may be an issue for femtocell deployments based on wideband technologies such as WCDMA, for example, because initial operator deployments may use the same frequency for both the femtocell and the macrocellular networks or due to the proximity of femtocell base stations in dense urban areas.

There are a plurality of design models for deployment and integration of femtocells, for example, an IP based lu-b interface, a session initiation protocol (SIP) based approach using an lu/A interface, use of unlicensed spectrum in a technique known as unlicensed mobile access (UMA) and/or use of IP multimedia subsystem (IMS) voice call continuity (VCC), for example.

In an lu-b model based femtocell deployment approach, femtocells may be fully integrated into the wireless carrier's network and may be treated like any other remote node in a network. The lu-b protocol may have a plurality of responsibilities, such as the management of common channels, common resources, and radio links along with configuration management, including cell configuration management, measurement handling and control, time division duplex (TDD) synchronization, and/or error reporting, for example. In lu-b configurations, mobile devices may access the network and its services via the Node B link, and femtocells may be treated as traditional base stations.

In a SIP based femtocell deployment approach, a SIP client, embedded in the femtocell may be enabled to utilize SIP to communicate with the SIP-enabled mobile switching center (MSC). The MSC may perform the operational translation between the IP SIP network and the traditional mobile network, for example.

In a UMA based femtocell deployment approach, a generic access network (GAN) may offer an alternative way to access GSM and GPRS core network services over broadband. To support this approach, a UMA Network Controller (UNC) and protocols that guarantee secure transport of signaling and user traffic over IP may be utilized. The UNC may be enabled to interface into a core network via existing 3GPP interfaces, for example, to support core network integration of femtocell based services by delivering a standards based, scalable IP interface for mobile core networks.

In an IMS VCC based femtocell deployment approach, VCC may provide for a network design that may extend an IMS network to include cellular coverage and address the handoff process. The IMS VCC may be designed to provide seamless call continuity between cellular networks and any network that supports VoIP, for example. The VCC may also provide for interoperability between GSM, UMTS, and CDMA cellular networks and any IP capable wireless access network, for example. The IMS VCC may also support the use of a single phone number or SIP identity and may offer a broad collection of functional advantages, for example, support for multiple markets and market segments, provisioning of enhanced IMS multimedia services, including greater service personalization and control, seamless handoff between circuit-switched and IMS networks, and/or access to services from any IP device.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for controlling parameters of a communication channel between a femtocell and a cellular enabled communication device, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a diagram illustrating an exemplary cellular network, in accordance with an embodiment of the invention.

FIG. 1B is a diagram illustrating communication with a cellular network comprising a femtocell, in accordance with an embodiment of the invention.

FIG. 1C is a diagram illustrating an exemplary block diagram of a femtocell, in accordance with an embodiment of the invention.

FIG. 1D is a block diagram of an exemplary cellular enabled communication device, in accordance with an embodiment of the invention.

FIG. 2 is a diagram illustrating exchange of feedback and network management messages to adapt parameters of cellular communication channels over which a femtocell communicates, in accordance with an embodiment of the invention.

FIG. 3 illustrates exemplary steps for controlling parameters of a cellular communication channel between a femtocell and a cellular enabled communication device, in accordance with an embodiment of the invention.

### DETAILED DESCRIPTION OF THE INVENTION

Certain embodiments of the invention may be found in a method and system for controlling parameters of a communication channel between a femtocell and a cellular enabled communication device. In various embodiments of the invention, characteristics of a cellular communication channel established between a cellular enabled communication device and a femtocell may be communicated to a network management entity. The network management entity may determine whether to adjust one or more parameters of the cellular communication channel based on the characteristics. The femtocell and/or the cellular enabled communication device may adjust the one or more parameters based on the determination by the management entity. The characteristics may be determined by the femtocell and/or the cellular enabled communication device. The characteristics may comprise one or more of signal strength, bit error rate, packet error rate, and/or available bandwidth. One or more of the characteristics may be measured in response to a change in one or more other characteristics. The parameters may comprise one or more of data rate, modulation scheme, error coding scheme, and transmitted power levels. Information about the cellular enabled communication device may also be communicated to the network management entity. Information about the cellular enabled communication device may comprise one or more of hardware configuration, software configuration, and transmit power capabilities. The network management entity may determine whether to adjust one or more of the parameters based on characteristics of other communication channels. The determination may be communicated to the femtocell via a broadband connection which may utilize the Internet Protocol (IP).

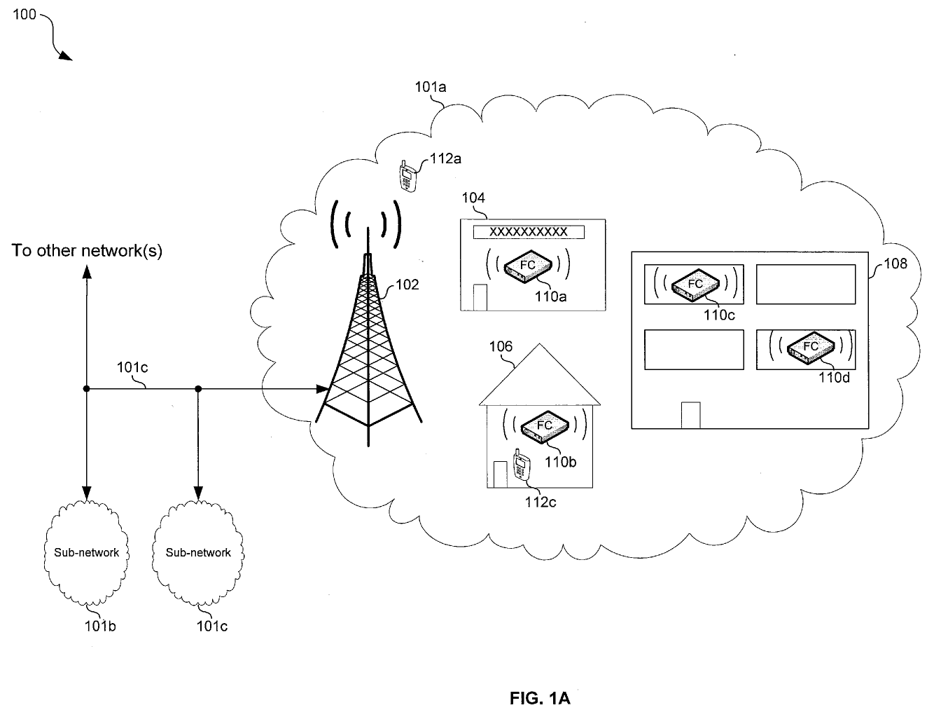

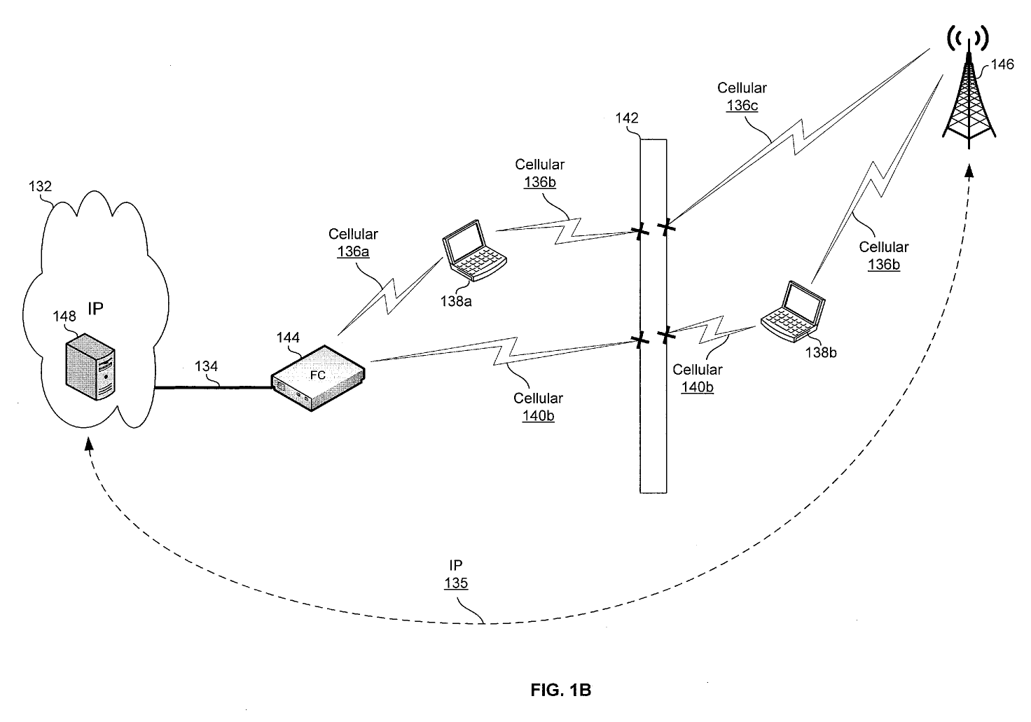

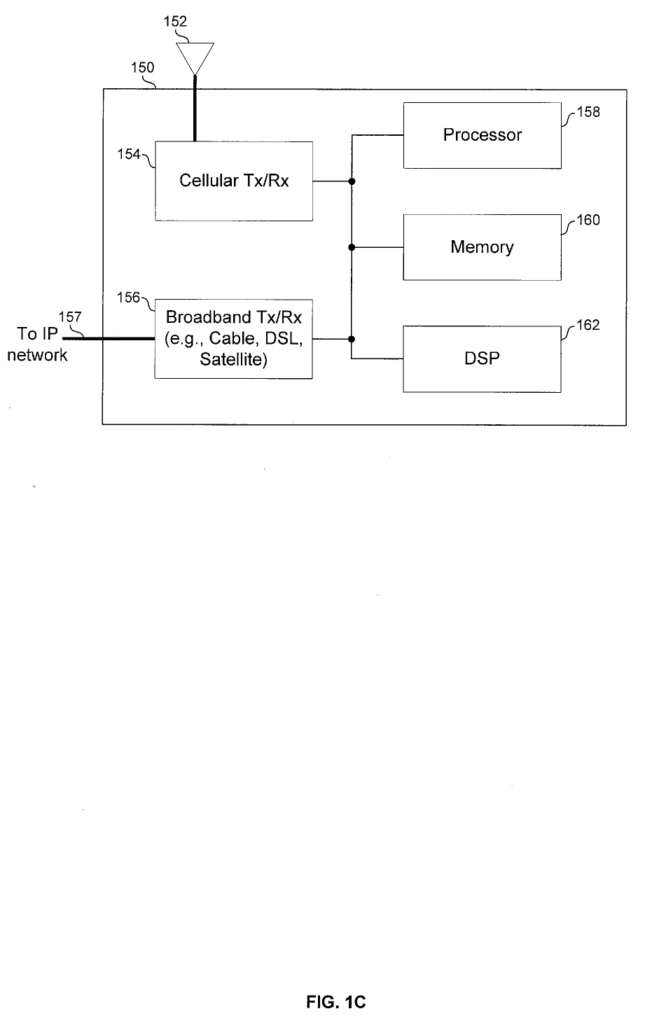

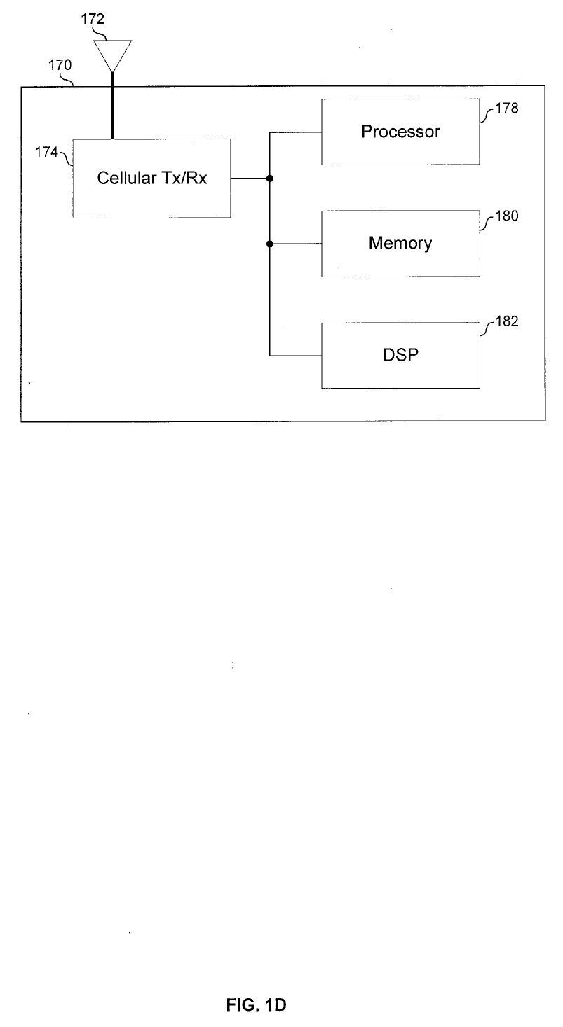

FIG. 1A is a diagram illustrating an exemplary cellular network, in accordance with an embodiment of the invention. Referring to FIG. 1A, there is shown a cellular network 100 comprising sub-networks 101a-101c. The exemplary sub-network 101a may comprise a base station 102, femtocells 110a-110d, which are collectively referred to herein as femtocells 110, and cellular enabled communication devices 112a and 112c, which are collectively referred to herein as cellular enabled communication devices 112. The femtocells 110 may be installed in one or more commercial properties 104, one or more residential properties 106, and/or one or more multi-tenant properties 108.

The commercial properties 104 may comprise, for example, stores, restaurants, offices, and municipal buildings. The residential properties 106 may comprise, for example, single-family homes, home offices, and/or town-houses. Multi-tenant properties 108 may comprise residential and/or commercial tenants such as apartments, condos, hotels, and/or high rises.

The base station 102 may be operable to communicate data wirelessly utilizing one or more cellular standards such as IS-95, CDMA, GSM, TDMA, GPRS, EDGE, UMTS/WCDMA, TD-SCDMA, HSDPA, extensions thereto, and/or variants thereof. “Data,” as utilized herein, may refer to any analog and/or digital information including but not limited to voice, Internet data, and/or multimedia content. Multimedia content may comprise audio and/or visual content comprising, video, still images, animated images, and/or textual content. The base station 102 may communicate with cellular enabled communication devices such as the cellular enabled communication devices 112. Exemplary cellular standards supported by the base station 102 may be specified in the International Mobile Telecomunnications-2000 (IMT-2000) standard and/or developed by the 3^{rd} generation partnership project (3GPP) and/or the 3^{rd} generation partnership project 2 (3GPP2). The base station 102 may communicate data amongst the various components of the sub-network 101a. Additionally, data communicated to and/or from the base station 102 may be communicated to sub-network 101b, sub-network 101c, and/or to one or more other networks (not shown) via one or more backhaul links 103. In this manner, data communicated to and/or from the base station 102 may be communicated to and/or from, other portions of the network 100 and/or other networks. Exemplary networks with which data may be communicated may comprise public switched telephone networks (PSTN) and/or IP networks such as the Internet or an intranet.

The femtocells 110 may each comprise suitable logic, circuitry, and/or code that may be operable to communicate wirelessly utilizing one or more cellular standards such as IS-95, CDMA, GSM, TDMA, GPRS, EDGE, UMTS/WCDMA, TD-SCDMA, HSDPA, extensions thereto, and/or variants thereof. In this regard, the femtocells 110 may each communicate with cellular enabled communication devices such as the cellular enabled communication devices 112. Exemplary cellular standards supported by the femtocells 110 may be specified in the International Mobile Telecomunnications-2000 (IMT-2000) standard and/or developed by the 3^{rd} generation partnership project (3GPP) and/or the 3^{rd} generation partnership project 2 (3GPP2). Additionally, the femtocells 110 may each comprise suitable logic, circuitry, and/or code that may be operable to communicate over an IP network (not shown in FIG. 1A). In various embodiments of the invention the femtocells 110, the sub-network 101c, and/or the network 100 may be managed by a service provider which licenses the cellular frequencies utilized. In this regard, the service provider may adapt one or more parameters of cellular communication channels between the femtocells 110 and the cellular enabled communication devices 112 by exchanging feedback, control, and/or management messages over an IP connection.

The cellular enabled communication devices 112 may each comprise suitable logic, circuitry, and/or code that may be operable to communicate utilizing one or more cellular standards. In this regard, the cellular enabled communication devices 112 may each be operable to transmit and/or receive data via the cellular network 100. Exemplary cellular enabled communication device may comprise laptop computers, mobile phones, and personal media players. The cellular enabled communication devices 112 may be enabled to receive, process, and present multimedia content and may additionally be enabled run a web browser or other applications for providing Internet services to a user of the cellular enabled communication device 112. In various embodiments of the invention, the cellular enabled communication devices 112 may control various parameters of one or more cellular communication channels over which they communicate based on network management and/or control messages received from a network management entity.

In operation, the cellular enabled communication devices 112 may gain access to the cellular network 100 and/or to other communication networks via cellular communications with the base station 102 and the femtocells 110. In this regard, in instances that a reliable connection may be established between the base station 102 and a cellular enabled communication device 112, then data may be communicated between the cellular enabled communication device 112 and the base station 102. Alternatively, in instances that a reliable connection may be established between a femtocell 110 and a cellular enabled communication device 112, then data may be communicated between the cellular enabled communication device 112 and the femtocell 110. Accordingly, the femtocells 110 may extend the cellular coverage area in the sub-network 101a. In particular, the femtocells 110 may extend or improve cellular coverage indoors or locations out of range of a base-station. In instances that a cellular enabled communication device communicates via a femtocell, the parameters of the communication channel(s) between the femtocell and the cellular enabled communication device may be controlled based on feedback, control, and/or management messages exchanged over a broadband connection between a femtocell 110 and a network management entity. Exemplary parameters may comprise a data rate of the channel, a modulation scheme of the channel, error coding schemes utilized for the channel, and transmitted power levels. Exemplary feedback may comprise received desired signal strength at the femtocell, received desired signal strength at the cellular enabled communication device, measured interference at the femtocell, measured interference at the cellular enabled communication device, bit error rates at the femtocell, bit error rates at the cellular enabled communication device, location of the cellular enabled communication device (e.g., Global navigation satellite system (GNSS) location coordinates), available bandwidth of the femtocell, and/or available bandwidth of the cellular enabled communication device. Additionally, feedback from a cellular enabled communication device may indicate the capabilities of that device. Exemplary capabilities which may be communicated may comprise a hardware configuration, a software configuration, maximum transmit power, and battery strength.

FIG. 1B is a diagram illustrating communication with a cellular network comprising a femtocell, in accordance with an embodiment of the invention. Referring to FIG. 1B, there is shown a femtocell 144, cellular enabled communication devices 138a and 138b (collectively referred to herein as cellular enabled communication devices 138), communication barrier 142, and base station 146. The femtocell 144 may be communicatively coupled to an IP network 132 via a connection 134.

The base station 146 may be similar to or the same as the base station 102 described with respect to FIG. 1B. The cellular enabled communication devices 138 may be similar to or the same as the cellular enabled communication devices 112 described with respect to FIG. 1A. The femtocell 144 may be similar to or the same as the femtocells 110 described with respect to FIG. 1A.

The IP network 132 may comprise one or more network devices and/or network links operable to transmit and/or receive IP packets. The IP network 132 may provide access to the Internet and/or one or more private networks.

The network management entity 148 may comprise one or more servers and/or computing devices which may manage various parameters of communication channels over which the femtocell 144 may communicated. In determining values for the various parameters, the network management entity 148 may utilize feedback received from the femtocell 144. After determining the parameter values, the management entity 148 may communicate the determinations to the femtocell 144. The management entity 148 and the femtocell may communicate utilizing IP via the connection 134.

The connection 134 may comprise a broadband connection such as a digital subscriber line (DSL), Ethernet, passive optical network (PON), a T1/E1 line, a cable television infrastructure, a satellite television infrastructure, and/or a satellite broadband Internet connection. The connection 134 may comprise one or more optical, wired, and/or wireless links.

The communications barrier 142 may comprise an obstruction to cellular communications. In some instances, the barrier 142 may comprise a physical barrier such as a building or mountainous terrain. In some instances, the barrier 142 may represent a distance which may be too great for reliable cellular communications. In some instances, the barrier 142 may represent interference or a limitation of channel capacity which may prevent cellular communications. The barrier 142 may prevent cellular communications between the base station 146 and the cellular enabled communication device 138a and may prevent cellular communications between the femtocell 144 and the cellular enabled communication device 138b.

In operation, the cellular enabled communication device 138a and the cellular enabled communication device 138b may communicate via the femtocell 144, the base station 146, and the IP network 132. For example, the cellular enabled communication device 138a may transmit data to the femtocell 144 utilizing one or more cellular standards. In various embodiments of the invention, parameters of the communication channel 136a between the femtocell 144 and the cellular enabled communication device 138a may be controlled via feedback, control, and/or management messages exchanged over the connection 134. In this manner, the communication channel may adapt to changing conditions. The femtocell 144 may packetize the data into one or more IP packets and the IP packets may be further encapsulated, encoded, modulated, or otherwise processed. The IP packets may then be routed via the IP network 132 to the base station 146. In some instances, the base station 146 may utilize IP backloading and the IP packets may be conveyed to the base station 146. In other instances, the IP packets may be transcoded via one or more network elements (not shown) to a format supported by the base station 146. The data may then be extracted from the IP packets, transcoded to a format suitable for cellular transmission, and subsequently transmitted to the cellular enabled communication device 138b. In this manner, the femtocell 144 may enable communication with the cellular enabled communication device 138a even in instances that the cellular enabled communication device 138a is unable to establish reliable cellular communications with a base station.

Although, FIG. 1B describes communication between a pair of cellular enabled communication devices via a single femtocell and a base station, communication with other equipment via one or more femtocells and an IP network may be similar to the communication described with respect to FIG. 1B. In this regard, devices which may communicate via one or more femtocells may comprise cellular enabled communication devices in other sub-networks, cellular enabled communication devices in different cellular networks, conventional “landline” phones coupled to a PSTN, IP phones, and computing devices such as PCs and fileservers coupled to an IP network.

FIG. 1C is a diagram illustrating an exemplary block diagram of a femtocell, in accordance with an embodiment of the invention. Referring to FIG. 1C, there is shown a femtocell 150 comprising an antenna 152, a cellular transmitter and/or receiver (Tx/Rx) 154, a broadband transmitter and/or receiver (Tx/Rx) 156, a processor 158, a memory 160, and a digital signal processor (DSP) 162. The femtocell 150 may be similar to or the same as the femtocells 110 described with respect to FIG. 1B.

The antenna 152 may be suitable for transmitting and/or receiving cellular signals. Although a single antenna is illustrated, the invention is not so limited. In this regard, the cellular Tx/Rx 154 may utilize a common antenna for transmission and reception, may utilize different antennas for transmission and reception, and/or may utilize a plurality of antennas for transmission and/or reception.

The cellular Tx/Rx 154 may comprise suitable logic circuitry and/or code that may be operable to transmit and/or receive voice and/or data utilizing one or more cellular standards. The cellular Tx/Rx 154 may be operable to perform amplification, down-conversion, filtering, demodulation, and analog to digital conversion of received cellular signals. The cellular Tx/Rx 154 may be operable to perform amplification, up-conversion, filtering, modulation, and digital to analog conversion of transmitted cellular signals. The cellular Tx/Rx 154 may support communication over a plurality of communication channels utilizing time division multiple access (TDMA) and/or code division multiple access (CDMA). Exemplary cellular standards supported by the femtocells 110 may be specified in the International Mobile Telecomunnications-2000 (IMT-2000) standard and/or developed by the 3^{rd} generation partnership project (3GPP) and/or the 3^{rd} generation partnership project 2 (3GPP2). In various embodiments of the invention, the cellular Tx/Rx 154 may be enabled to measure received signal strength. Additionally, the cellular Tx/Rx 154 may be enabled to adjust a power level and/or a modulation scheme or level of transmitted signals.

The broadband Tx/Rx 156 may comprise suitable logic, circuitry, and/or code that may be operable to transmit voice and/or data in adherence to one or more broadband standards. The broadband Tx/Rx 156 may be operable to perform amplification, down-conversion, filtering, demodulation, and analog to digital conversion of received signals. The broadband Tx/Rx 156 may be operable to perform amplification, up-conversion, filtering, modulation, and digital to analog conversion of transmitted signals. In various exemplary embodiments of the invention, the broadband Tx/Rx 156 may transmit and/or receive voice and/or data over the link 157 which may comprise, for example, a T1/E1 line, PON, DSL, cable television infrastructure, satellite broadband internet connection, satellite television infrastructure, and/or Ethernet.

The processor 158 may comprise suitable logic, circuitry, and/or code that may enable processing data and/or controlling operations of the femtocell 150. In this regard, the processor 158 may be enabled to provide control signals to the various other blocks comprising the femtocell 150. The processor 158 may also control data transfers between various portions of the femtocell 150. Additionally, the processor 158 may enable execution of applications programs and/or code. In various embodiments of the invention, the applications, programs, and/or code may enable, for example, parsing, transcoding, or otherwise processing data. In various embodiments of the invention, the applications, programs, and/or code may enable, for example, configuring or controlling operation of the cellular transmitter and/or receiver 154, the broadband transmitter and/or receiver 156, the DSP 162, and/or the memory 160. In various embodiments of the invention, the processor 158 may be enabled to provide one or more signals to the cellular Tx/Rx 154, the memory 160, and/or the DSP 162 to control parameters such as power level, modulation scheme, error coding scheme, and/or data rates of transmitted cellular signals.

The memory 160 may comprise suitable logic, circuitry, and/or code that may enable storage or programming of information that includes parameters and/or code that may effectuate the operation of the femtocell 150. The parameters may comprise configuration data and the code may comprise operational code such as software and/or firmware, but the information need not be limited in this regard. Moreover, the parameters may include adaptive filter and/or block coefficients. Additionally, the memory 160 may buffer or otherwise store received data and/or data to be transmitted. In various embodiments of the invention, the memory 150 may comprise one or more look-up tables which may be utilized for determining cellular enabled communication devices within a coverage area of the femtocell 150.

The DSP 162 may comprise suitable logic, circuitry, and/or code operable to perform computationally intensive processing of data. In various embodiments of the invention, the DSP 162 may encode, decode, modulate, demodulate, encrypt, decrypt, scramble, descramble, and/or otherwise process data. In various embodiments of the invention, the DSP 162 may be enabled adjust a modulation scheme, error coding scheme, and/or data rates of transmitted cellular signals data.

In operation, the cellular Tx/Rx 154 may determine characteristics such as interference levels and signal strength of desired signals received via a cellular communication channel. Similarly, the DSP 162 and/or the processor 156 may determine bit error rates of data received via a cellular communication channel and available bandwidth of the channel. The measurements may be communicated to a network management entity by the Broadband Tx/Rx 156 via the link 157. Additionally, the femtocell 150 may receive feedback about from a cellular enabled communication device on the other end of a cellular communication channel; that feedback may also be communicated to a central management entity by the Broadband Tx/Rx 156 via the link 157.

The Broadband Tx/Rx 156 may also receive network management messages from the central management entity. The processor 158 may utilize the received management messages to configure the cellular Tx/Rx 154 and/or the DSP 162 to control parameters of the communication channel such as transmitted cellular signal strength, error coding scheme for transmitted cellular signals, data rates for transmitted cellular signals, and modulation scheme for transmitted signals. Additionally, management messages may be relayed to the cellular enabled communication device via the cellular Tx/Rx 154.

FIG. 1D is a block diagram of an exemplary cellular enabled communication device, in accordance with an embodiment of the invention. The cellular enabled communication device 170 may comprise a cellular Tx/Rx 174, a processor 178, a memory 180, and a DSP 182.

The cellular Tx/Rx 174 may be similar to or the same as the cellular Tx/Rx 154 described with respect to FIG. 1C. The processor 178 may be similar to or the same as the processor 158 described with respect to FIG. 1C. The memory 180 may be similar to or the same as the memory 160 described with respect to FIG. 1C. The DSP 182 may be similar to or the same as the DSP 162 described with respect to FIG. 1C.

In operation, the cellular Tx/Rx 174 may determine interference levels and/or received signal strength for cellular communication channels over which it communicates. Similarly, the DSP 182 and/or the processor 176 may determine a data rate and/or a bit error rate of data received via cellular communication channels over which it communicates. The determinations may be communicated to a femtocell via a cellular communication channel.

The cellular enabled communication device 170 may also receive, via the femtocell, control and/or management messages from a network management entity. The processor 178 may utilize the received control and/or management messages to configure, for example, the cellular Tx/Rx 154 and/or the DSP 162 to control parameters such as transmitted cellular signal strength, error coding scheme for transmitted cellular signals, data rates for transmitted cellular signals, and modulation scheme for transmitted signals.

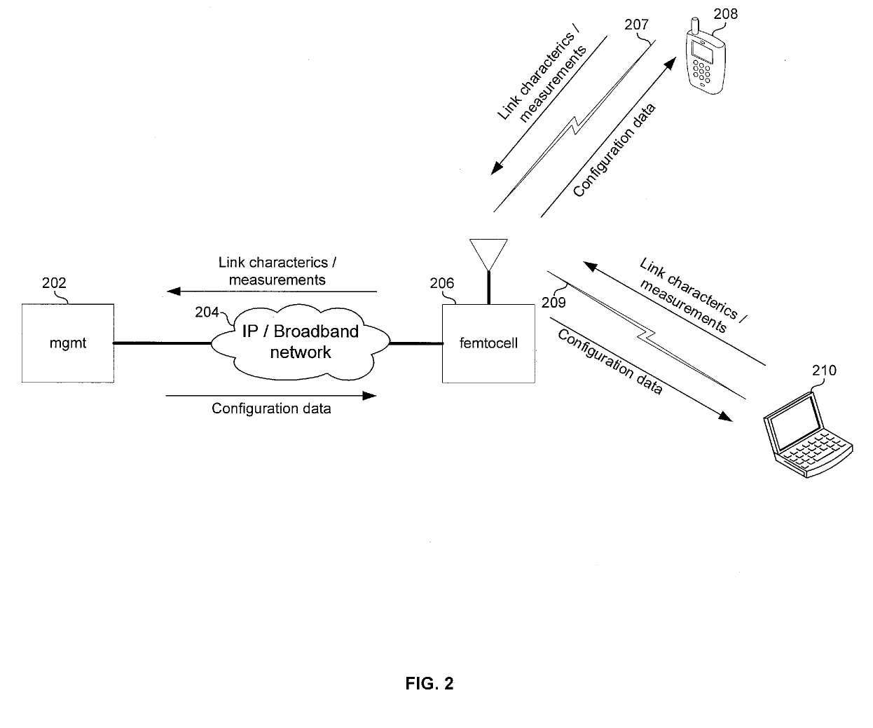

FIG. 2 is a diagram illustrating exchange of feedback and network management messages to control parameters of cellular communication channels over which a femtocell communicates, in accordance with an embodiment of the invention. Referring to FIG. 2, there is shown a network management entity 202, a network 204, a femtocell 206, a cellular enabled communication device 208, and a cellular enabled communication device 210.

The network management entity 202, may be similar to or the same as the network management entity 148 described with respect to FIG. 1B. The femtocell may be similar to or the same as the femtocell 150 described with respect to FIG. 1C. The cellular enabled communication devices 208 and 210 may be similar to or the same as the cellular enabled communication device 170 described with respect to FIG. 1B.

In operation, the femtocell 206 may communicate with the cellular enabled communication devices 208 and 210 via the communication channels 207 and 209, respectively. The femtocell 206 may measure or characterize the channels 207 and 209. The cellular enabled communication devices 208 and 210 may also measure and/or characterize the channels 207 and 209, respectively. In this regard, various characteristics of the communication channels 207 and 209 may be continuously monitored or periodically measured. In some embodiments of the invention, periodic and/or a periodic measurements of one or more characteristics of the communication channel may be performed in response to detected changes in monitored communication channel characteristics. One or more parameters of the communication channels 207 and 209 may be controlled to adapt the channel to changing conditions in, for example, the environment, the type and/or amount of data being communicated, and/or the location of the cellular enabled communication devices 208 and 210.

Measurements and/or characterizations of the channels 207 and 209 performed by the femtocell 202 and the cellular enabled communication devices 208 and 210 may be conveyed to the network management entity 202 via the network 204. The network management entity 202 may utilize the measurements and/or characterizations to determine whether to change any parameters associated with the communication channels 207 and/or 209. For example, if the received signal strength of the cellular enabled communication device 208 is low, the network management entity 202 may send a control and/or management message to boost the output power of the femtocell 206. Similarly, if the error rate of received data from the cellular enabled communication device 210 is too high, the network management entity 202 may send a management message for the femtocell 206 and the cellular enabled communication device 210 to utilize a different error coding scheme for the channel 209. Exemplary error rates comprise bit error rate (BER) and packet error rates (PER). In determining parameter values for the femtocell 204 and the cellular enabled communication devices 208 and 210, the network management entity 202 may also consider measurements and/or characterization from other femtocells, other cellular enabled communication devices, and/or base stations.

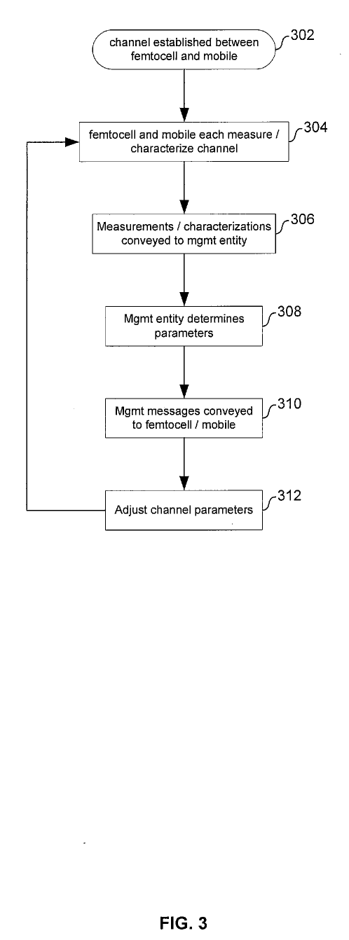

FIG. 3 illustrates exemplary steps for controlling parameters of a cellular communication channel between a femtocell and a cellular enabled communication device, in accordance with an embodiment of the invention. Referring to FIG. 3, the exemplary steps may begin with step 302 when a cellular communication channel may be established between a femtocell and a cellular enabled communication device. Subsequent to step 302, the exemplary steps may advance to step 304.

In step 304, the femtocell and the cellular enabled communication device may determine one or more characteristics of the communication channel established in 302. In some embodiments of the invention, the determination may be triggered by a change in the characteristics communication channel. Subsequent to step 304, the exemplary steps may advance to step 306.

In step 306, feedback, may be communicated to a network management entity via an IP connection to the femtocell. In this regard, the feedback may comprise characteristics of the communication channel determined in step 304; and possibly other information about the cellular enabled communication device and/or femtocell. Subsequent to step 306, the exemplary steps may advance to step 308.

In step 308, the management entity may utilize the feedback to determine whether changing any parameters of the communication channel may improve communications on the channel without having a critical negative impact on other communication channels. Subsequent to step 308, the exemplary steps may advance to step 310.

In step 310 the management entity may send one or more network management messages that may, based on the determination in step 308, direct the femtocell and/or the cellular enabled communication device to adjust one or more parameters of the communication channel. Subsequent to step 310, the exemplary steps may advance to step 312.

In step 312, one or more parameters of the communication channel may be adjusted based on the network management messages. Subsequent to step 312, the exemplary steps may return to the previously described step 304.

Exemplary aspects of a method and system for controlling parameters of a communication channel between a femtocell and a cellular enabled communication device are provided. In an exemplary embodiment of the invention, characteristics of a cellular communication channel 207 (FIG. 2) established between a cellular enabled communication device 208 and a femtocell 206 (FIG. 2) may be communicated to a network management entity 202. The network management entity 202 (FIG. 2) may determine whether to adjust one or more parameters of the cellular communication channel 207 based on the characteristics. The femtocell 206 and/or the cellular enabled communication device 207 may adjust the one or more parameters based on the determination by the management entity 202. The characteristics may be determined by the femtocell 206 and/or the cellular enabled communication device 207. The characteristics may comprise one or more of signal strength, bit error rate, packet error rate, and/or available bandwidth. One or more of the characteristics may be measured in response to a change in one or more other characteristics. The parameters may comprise one or more of data rate, modulation scheme, error coding scheme, and transmitted power levels. Information about the cellular enabled communication device 207 may also be communicated to the network management entity 202. Information about the cellular enabled communication device 207 may comprise one or more of hardware configuration, software configuration, and transmit power capabilities. The network management entity 202 may determine whether to adjust one or more of the parameters based on characteristics of other communication channels. The determination may be communicated to the femtocell 206 via a broadband connection which may utilize the Internet Protocol (IP).

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for controlling parameters of a communication channel between a femtocell and a cellular enabled communication device.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communication, the method comprising:
communicating, via a femtocell, characteristics of a cellular communication channel, which is established between a cellular enabled communication device and said femtocell, to a network management entity that determines whether to adjust one or more parameters of said cellular communication channel based on said characteristics; and
adjusting said one or more parameters of said cellular communication channel based on said determination by said network management entity.

2. The method according to claim 1, comprising determining said characteristics by said cellular enabled communication device.

3. The method according to claim 1, comprising determining said characteristics by said femtocell.

4. The method according to claim 1, wherein said characteristics comprise one or more of signal strength, bit error rate, packet error rate, and/or available bandwidth.

5. The method according to claim 1, wherein said one or more parameters comprise one or more of data rate, modulation scheme, error coding scheme, and transmitted power levels.

6. The method according to claim 1, comprising communicating information about said cellular enabled communication device to said network management entity.

7. The method according to claim 6, wherein said information may comprise one or more of hardware configuration, software configuration, and transmit power capabilities.

8. The method according to claim 1, wherein said network management entity determines whether to adjust one or more of said parameters based on characteristics of other communication channels.

9. The method according to claim 1, comprising communicating said determination to said femtocell via a broadband connection.

10. The method according to claim 9, wherein said broadband connection utilizes the Internet Protocol (IP).

11. The method according to claim 1, measuring one or more of said characteristics in response to a change in one or more other of said characteristics.

12. A system for communication, the system comprising:
one or more circuits for use in a femtocell and/or a cellular enabled communication device, wherein said one or more circuits are operable to:
communicate characteristics of a cellular communication channel, which is established between a cellular enabled communication device and said femtocell, to a network management entity that determines whether to adjust one or more parameters of said cellular communication channel based on said characteristics; and
adjust said one or more parameters of said cellular communication channel based on said determination by said network management entity.

13. The system according to claim 12, wherein said one or more circuits in said cellular enabled communication device determine said characteristics.

14. The system according to claim 12, wherein said one or more circuits in said femtocell determine said characteristics.

15. The system according to claim 12, wherein said characteristics comprise one or more of signal strength, bit error rate, packet error rate, and/or available bandwidth.

16. The system according to claim 12, wherein said one or more parameters comprise one or more of data rate, modulation scheme, error coding scheme, and transmitted power levels.

17. The system according to claim 12, wherein said one or more circuits communicate information about said cellular enabled communication device to said network management entity.

18. The system according to claim 17, wherein said information may comprise one or more of hardware configuration, software configuration, and transmit power capabilities.

19. The system according to claim 12, wherein said network management entity determines whether to adjust one or more of said parameters based on characteristics of other communication channels.

20. The system according to claim 12, wherein said one or more circuits communicate said determination to said femtocell via a broadband connection.

21. The system according to claim 20, wherein said broadband connection utilizes the Internet Protocol (IP).

22. The system according to claim 12, wherein said one or more circuits measure one or more of said characteristics in response to a change in one or more other of said characteristics.
